(19) United States
(12) Patent Application Publication
(10) Pub. No.: US 2024/0080681 A1
(43) Pub. Date: Mar. 7, 2024

(54) SYSTEMS AND METHODS FOR ADJUSTING SIGNAL TRANSMISSION FOR AN ELECTRONIC DEVICE

(71) Applicant: Apple Inc., Cupertino, CA (US)

(72) Inventors: Dhruv Khati, San Jose, CA (US); Sanjeevi Balasubramanian, San Jose, CA (US); Shiva Krishna Narra, San Jose, CA (US); Krishna Myneni, Santa Clara, CA (US); Anjaneyulu Maganti, San Jose, CA (US)

(21) Appl. No.: 17/902,488

(22) Filed: Sep. 2, 2022

(51) Int. Cl. H04W 16/28; H04W 76/10

(52) U.S. Cl. CPC H04W 16/28; H04W 76/10

(57) ABSTRACT

An electronic device includes a transmitter and processing circuitry. The processing circuitry determines trends of positions (e.g., elevation angles) of communication nodes and compare the trends of the positions. Based on the comparison between the trends of the positions, the processing circuitry selects a communication node for communication and uses the transmitter to transmit a signal to the selected communication node.

### BACKGROUND

The present disclosure relates generally to wireless communication, and more specifically to selecting a communication node used for communicating signals, such as those carrying data.

A mobile communication device (e.g., user equipment) may communicate signals (e.g., signals that include data) via a communication node, such as a non-terrestrial station, a satellite, and/or a high altitude platform station. For instance, the mobile communication device may transmit a signal to the communication node, and the communication node may forward the signal to a destination device. It is now recognized that operation of the mobile communication device to transmit a signal to the communication node may be improved. For example, the mobile communication device and the communication node may move relative to one another. Relative movement between the mobile communication device and the communication node may reduce a line of sight between the mobile communication device and the communication node, thereby reducing potential for successful receipt of a signal transmitted by the mobile communication device directed to the communication node. As a result, an intended recipient may not receive the signal transmitted by the mobile communication device.

### SUMMARY

In one embodiment, an electronic device includes a transmitter and processing circuitry communicatively coupled to the transmitter. The processing circuitry is configured to transmit a signal directed to a first communication node using the transmitter and transmit a signal directed to the second communication node using the transmitter instead of directed to the first communication node based on a trend of a position of the second communication node.

In another embodiment, a non-transitory computer-readable medium includes instructions that, when executed by processing circuitry, are configured to cause the processing circuitry to transmit a signal directed to a first communication node using a transmitter of an electronic device and transmit an additional signal directed to the second communication node using the transmitter instead of directed to the first communication node based on a first trend of a first elevation angle with respect to the electronic device and a second trend of a second elevation angle with respect to the electronic device.

In yet another embodiment, a method includes determining, via processing circuitry of an electronic device, a plurality of parameters corresponding to a communication node, the plurality of parameters comprising a trend of an elevation angle between the communication node and the electronic device, determining, via the processing circuitry, a duration of time based on the plurality of parameters, and attempting, via the processing circuitry, to establish a communication link between the electronic device and the communication node within the duration of time.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a communication system including the electronic device of FIG. 1, according to embodiments of the present disclosure;

FIG. 4 is a flowchart of a method for switching between communication nodes used to transmit a signal via the electronic device of FIG. 1, according to embodiments of the present disclosure; and

FIG. 5 is a flowchart of a method for establishing a communication link with a communication node via the electronic device of FIG. 1, according to embodiments of the present disclosure.

### DETAILED DESCRIPTION OF SPECIFIC EMBODIMENTS

This disclosure is directed to selecting a communication node for relaying signals transmitted by a mobile communication device. The mobile communication device may initially transmit a signal to a communication node, and the communication node may forward the signal received from the mobile communication device to a destination device (e.g., a communication hub, another mobile communication device). For example, the signal may include or be associated with one of various forms of communication, such as emergency text messaging, emergency voice calling, acknowledgement messaging, video streaming, Internet browsing, and so forth.

The mobile communication device and the communication node may move relative to one another. Relative movement between the mobile communication device and the communication node may affect potential or likelihood of successful transmission of a signal from the mobile communication device to the communication node. As an example, relative movement between the mobile communication device and the communication node may adjust a line of sight between the mobile communication device and the communication node. For instance, increasing an elevation angle between the mobile communication device and the communication node may improve the line of sight between the mobile communication device and the communication node. As such, the communication node may more readily receive a signal transmitted from the mobile communication device and correspondingly forward the signal to the destination device. However, reducing the elevation angle between the mobile communication device and the communication node may worsen or cause obstruction of the line of sight between the mobile communication device and the communication node, thereby reducing the potential or likelihood of the communication node receiving a signal transmitted from the mobile communication device and correspondingly forwarding the signal to the destination device. In this manner, the elevation angle may be indicative of a potential successful signal transmission from the mobile communication device to the communication node.

In some embodiments, the mobile communication device may adjust between available communication nodes for communicating signals. For example, it may be desirable to utilize a communication node that may be most readily able to receive a signal transmitted by the mobile communication device. For this reason, the mobile communication device may determine the respective elevation angles between the mobile communication device and different communication nodes and utilize a communication node based on the determined elevation angles.

As an example, the mobile communication device may determine trends of the respective elevation angles. In other words, the mobile communication device may project a future elevation angle based on previous, recent, or historical elevation angles. The mobile communication device may select a communication node for communicating signals based on the trends. As an example, the mobile communication device may currently communicate via a first communication node. However, in response to determining that a first elevation angle of the first communication node is decreasing over time (e.g., a first line of sight between the mobile communication device and the first communication node is deteriorating) and/or a second elevation angle of a second communication node is increasing over time (e.g., a second line of sight between the mobile communication device and the second communication node is improving) due to movement of the mobile communication device, the first communication node, and/or the second communication node, the mobile communication device may prepare to switch from communicating via the first communication node to communicating via the second communication node. That is, the mobile communication device may communicate via the second communication node instead of via the first communication node, because the movement of the second communication node relative to the mobile communication device may enable the second communication node to more readily receive a subsequent signal transmitted by the mobile communication device.

In some embodiments, the mobile communication device may determine a first operating characteristic (e.g., received signal strength, received signal quality) associated with the first communication node and a second operating characteristic (e.g., received signal strength, received signal quality) associated with the second communication node to verify that the mobile communication device is to switch between communication nodes. As an example, in response to determining the second operating characteristic is more greater than or more conducive to communication the first operating characteristic, the mobile communication device may confirm that the second communication node, instead of the first communication node, is to be utilized for communicating signals. The operating characteristic, or any other suitable operating characteristics of the first and second communication nodes, may further indicate the potential for successful receipt of a signal transmitted by the mobile communication device. In this manner, by comparing the operating characteristics, the mobile communication device may better determine which communication node may more readily receive a signal from the mobile communication device to improve operation of the mobile communication device to communicate signals. Although the present disclosure primarily discusses the operating characteristics as being received signal strengths, any suitable operating characteristic may be utilized in the techniques discussed herein.

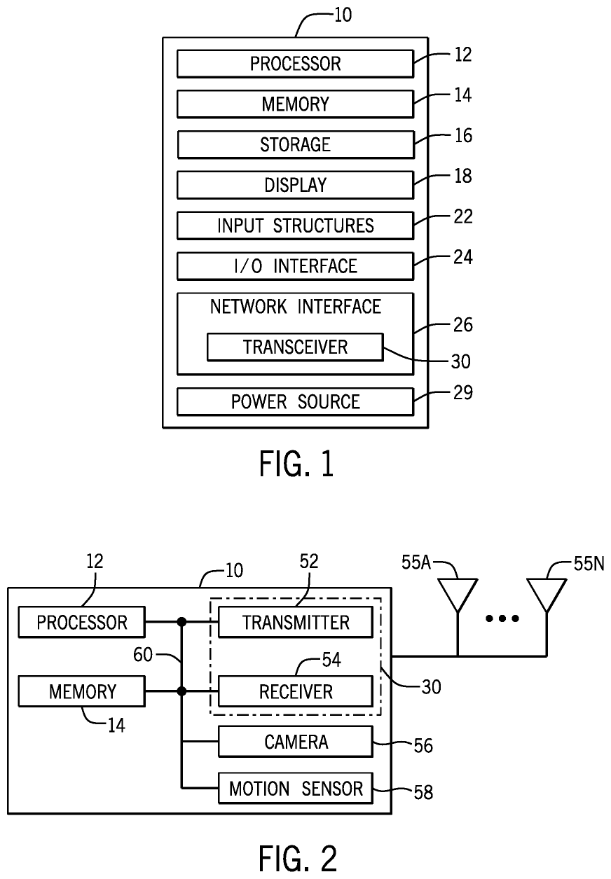

With the preceding in mind, FIG. 1 is a block diagram of an electronic device, user equipment, or mobile communication device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a satellite connection (e.g., via a satellite network), a peer-to-peer connection, a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5th generation (5G) cellular network, New Radio (NR) cellular network, 6^{th} generation (6G) cellular network and beyond, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)). The network interface 26 of the electronic device 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth. The network interface 26 may, for instance, include a transceiver 30 for communicating signals using one of the aforementioned networks. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively transmit and receive signals between the electronic device 10 and an external device via, for example, a network (e.g., including base stations) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. For example, the electronic device 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The electronic device 10 may also include one or more cameras or image or light sensors (e.g., as part of the input structures 22). The one or more cameras or image or light sensors (collectively referred to as “a camera 56” herein) may capture images and/or determine amounts of light surrounding the electronic device 10. In some embodiments, the camera 56 may include a front-facing camera (e.g., disposed on a display surface of the electronic device 10 having the display 18) and/or a rear-facing camera (e.g., disposed on a base or back surface, opposite the display surface, of the electronic device 10).

The electronic device 10 may include one or more motion sensors 58 (e.g., as part of the input structures 22). The one or more motion sensors (collectively referred to as “a motion sensor 58” herein) may include an accelerometer, gyroscope, gyrometer, and the like, that detect and/or facilitate determining an orientation (e.g., including pitch, yaw, roll, and so on) and/or motion of the electronic device 10.

As illustrated, the various components of the electronic device 10 may be coupled together by a bus system 60. The bus system 60 may include a data bus, for example, as well as a power bus, a control signal bus, and a status signal bus, in addition to the data bus. The components of the electronic device 10 may be coupled together or accept or provide inputs to each other using some other mechanism.

As discussed above, the electronic device 10 may select a communication node for communicating a signal to a recipient. Embodiments herein provide various apparatuses and techniques to improve selection of a communication node to increase potential for successful transmission of the signal to the recipient. For example, the electronic device 10 may determine trends of respective elevation angles between the electronic device 10 and different communication nodes. In response to determining that a first elevation angle between the electronic device 10 and a current communication node (e.g., a serving communication node) is decreasing over time and a second elevation angle between the electronic device 10 and another communication node (e.g., a nearby communication node) is increasing over time, the electronic device 10 may determine a received signal strength, a received signal quality, or another suitable operating characteristic (e.g., of an initial or test signal transmitted by the electronic device 10) associated with each of the current communication node and the other communication node. In response to determining that a first received signal strength associated with the current communication node is greater than a second received signal strength associated with the other communication node, the electronic device 10 may continue to communicate via the current communication node. However, in response to determining that the second received signal strength is greater than the first received signal strength, the electronic device 10 may switch (e.g., handover, changeover) to communicate via the other communication node instead of via the current communication node. That is, the electronic device 10 may output a subsequent signal directed to the other communication node instead of directed to the current communication node.

In this manner, the electronic device 10 may transmit a signal to a more suitable communication node that may more readily receive the signal, and increase the likelihood of the signal being delivered to its destination device. Additionally, the electronic device 10 may avoid constantly monitoring received signal strengths associated with available communication nodes to determine whether to switch communication nodes. Indeed, the electronic device 10 may limit determining received signal strengths to when a communication node different than a currently used communication node appears to have better potential for receiving a signal based on trends of elevation angles. Thus, communication of the signal may be improved by decreasing or without increasing a power consumption associated with constantly determining received signal strengths (e.g., determining received signal strengths at a particular interval regardless of elevation angles).

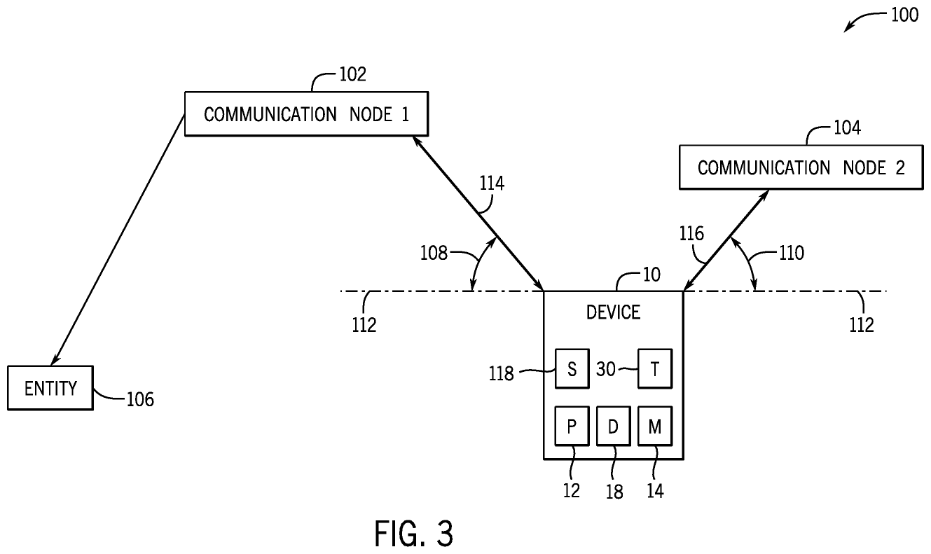

With the preceding in mind, FIG. 3 is a schematic diagram of a communication system 100 including the electronic device 10, according to embodiments of the present disclosure. The communication system 100 includes a first communication node 102 and a second communication node 104, which may include any combination of non-terrestrial base stations, high altitude platform stations, airborne base stations, spaceborne base stations, satellites, and/or any other suitable nonstationary communication node, communicatively coupled to the electronic device 10, which may be implemented as user equipment. The first communication node 102 and/or the second communication node 104 may be communicatively coupled to an entity 106, such as another electronic device, another mobile communication device, another user equipment, a terrestrial base station, a ground station, a call center, an access point, and so forth, to enable communication of signals between the entity 106 and the electronic device 10. For example, the electronic device 10, via the transceiver 30, may transmit a signal to one of the communication nodes 102, 104 communicatively coupled to the electronic device 10 for subsequent forwarding of the signal to the entity 106. Additionally or alternatively, the entity 106 may transmit a signal to one of the communication nodes 102 communicatively coupled to the entity 106 for subsequent forwarding of the signal to the electronic device 10 for receipt, such as via the transceiver 30.

The electronic device 10 may select from either of the communication nodes 102, 104 to communicate a signal to the entity 106. That is, the electronic device 10 may determine whether to utilize the first communication node 102 or the second communication node 104 for communication of signals. For instance, the electronic device 10, via the processor 12, may determine a parameter (e.g., signal strength, signal quality) indicative of a communication quality between the electronic device 10 and each of the communication nodes 102, 104. The electronic device 10 may transmit a signal directed to the communication node 102, 104 that may have the higher communication quality and the greater potential for successful receipt of the signal (e.g., at a sufficient or threshold receive quality or power). That is, in response to determining that a first parameter of communication quality between the electronic device 10 and the first communication node 102 is greater than a second parameter of communication quality between the electronic device 10 and the second communication node 104, the electronic device 10 may transmit a signal directed to the first communication node 102, as shown in the illustrated embodiment. However, in response to determining that the second parameter of communication quality between the electronic device 10 and the second communication node 104 is greater than the first parameter of communication quality between the electronic device 10 and the first communication node 102, the electronic device 10 may transmit a signal directed to the second communication node 104 instead of directed to the first communication node 102.

In some embodiments, the parameter of communication quality may include or be related to a relative positioning between the communication nodes 102, 104 and the electronic device 10. As an example, the processor 12 may determine a first elevation angle 108 of the first communication node 102 relative to the electronic device 10, as well as a second elevation angle 110 of the second communication node 104 relative to the electronic device 10. The first elevation angle 108 may include an angle spanning between a horizon 112 and a first line of sight 114 between the first communication node 102 and the electronic device 10, and the second elevation angle 110 may include an angle spanning between the horizon 112 and a second line of sight 116 between the second communication node 104 and the electronic device 10. The elevation angles 108, 110 may be indicative of a respective potential communication quality between the communication nodes 102, 104 and the electronic device 10. For example, a greater elevation angle 108, 110 (e.g., an angle closer to 90 degrees, such as between 80 and 90 degrees, between 70 and 90 degrees, between 60 and 90 degrees, between 45 and 90 degrees, between 30 and 90 degrees, and so on) may indicate potentially reduced obstruction or interference (e.g., by a building, by foliage, by signals transmitted via other devices) of the corresponding line of sight 114, 116, and therefore indicate potentially improved communication quality. A smaller elevation angle 108, 110 (e.g., an angle closer to 0 degrees, such as between 0 and 10 degrees, between 0 and 20 degrees, between 0 and 30 degrees, between 0 and 45 degrees, and so on) may indicate potentially increased obstruction of the corresponding line of sight 114, 116 and therefore indicate potentially reduced communication quality.

The elevation angles 108, 110 may change over time. For example, the communication nodes 102, 104 may move relative to the electronic device 10 (e.g., as a part of scheduled operation of the communication nodes 102, 104) and/or the electronic device 10 may move relative to the communication nodes 102, 104 (e.g., as caused by movement of a user of the electronic device 10). Relative movement between the communication nodes 102, 104 and the electronic device 10 may adjust the elevation angles 108, 110, and therefore the communication qualities, between the communication nodes 102, 104 and the electronic device 10. Thus, a different communication node 102, 104 may more readily receive a signal transmitted by the electronic device 10 and may be more suitable for communication with the electronic device 10 at different times. In some circumstances, each of the elevation angles 108, 110 may alternate or cycle between increasing (e.g., at a rising edge) up to a peak angle and then decreasing (e.g., at a falling edge) to a low angle. Thus, subsequent values of the elevation angles 108, 110 may be projected based on the trend of the elevation angles 108, 110. In other words, a previous value (e.g., a most recent value) of one of the elevation angle 108, 110 may indicate a future value (e.g., an upcoming value) of the elevation angle 108, 110.

For this reason, the electronic device 10 may determine the movement of the communication nodes 102, 104 and/or of the electronic device 10 to determine or project the elevation angles 108, 110, compare the movements with respect to one another, and correspondingly select a suitable communication node 102, 104 for communicating signals. In some embodiments, the electronic device 10 may determine the movements of the communication nodes 102, 104 based on pre-stored or pre-recorded data (e.g., stored in the memory 14 and/or the storage 16). For example, the electronic device 10 may initially receive data (e.g., two-line element set (TLE) data or ephemeris data) associated with positionings, trajectories, and/or movement of the communication nodes 102, 104, such as positionings of the communication nodes 102, 104 at different times. Additionally or alternatively, the electronic device 10 may actively determine the movement of the communication nodes 102, 104. By way of example, the electronic device 10 may include a sensor 118 that determines various operating parameters that may be associated with movement of the communication nodes 102, 104 and/or the electronic device 10, such as a property associated with movement of the Earth (e.g., a gravitational property, an orbit of the Earth), a historical positioning of the communication nodes 102, 104, a motion of the electronic device 10, and the like. The processor 12 may receive the determined operating parameters from the sensor 118 as sensor data and determine the location and/or orientation of the communication nodes 102, 104 based on the operating parameters, such as by using a mathematical model that associates the positioning of the communication nodes 102, 104 with values of the operating parameters. The processor 12 may operate the transceiver 30 to transmit a signal directed to one of the communication nodes 102, 104 based on the determined relative positionings.

In some embodiments, the processor 12 may switch (e.g., handover, changeover) between communicating via different communication nodes 102, 104 based on a trend of the elevation angles 108, 110. As an example, the processor 12 may initially communicate via the first communication node 102. For instance, prior to establishing a communication link with either of the communication nodes 102, 104, the processor 12 may initially acquire a received signal strength or another suitable operating characteristic associated from the first communication node 102 in response to determining the first elevation angle 108 between the first communication node 102 and the electronic device 10 is above a threshold angle (e.g., an angle between 10 and 20 degrees, an angle less than 10 degrees) and has an increasing trend (e.g. is increasing in angle over time). The processor 12 may then establish a communication link with the first communication node 102 in response to determining the received signal strength is above a threshold value. While the electronic device 10 communicates via the first communication node 102, the electronic device 10 may continue to monitor the trend of the first elevation angle 108 between the first communication node 102 and the electronic device 10.

The electronic device 10 may also monitor the trend of the second elevation angle 110 between the second communication node 104 and the electronic device 10 while the electronic device 10 communicates via the first communication node 102. As an example, the second communication node 104 may move along with (e.g., in parallel with) the first communication node 102. For instance, at least a portion of the rising edge of the first elevation angle 108 (e.g., in which the first elevation angle 108 increases over time) may overlap with the rising edge of the second elevation angle 110 (e.g., in which the second elevation angle 110 increases over time), and/or at least a portion of the falling edge of the first elevation angle 108 (e.g., in which the first elevation angle 108 decreases over time) may overlap with the falling edge of the second elevation angle 110 (e.g., in which the second elevation angle 110 decreases over time). In such a scenario, the second communication node 104 may be referred to as a neighbor communication node with respect to the first communication node 102. As another example, the second communication node 104 may be scheduled (e.g., based on stored values of the elevation angles 108, 110) to communicate with the electronic device 10 after the first communication node 102 is no longer available, such as when the first elevation angle 108 has decreased below a threshold angle. In such an example, the rising edge of the first elevation angle 108 may not overlap with the rising edge of the second elevation angle 110, and/or the falling edge of the first elevation angle 108 may not overlap with the falling edge of the second elevation angle 110. In such a scenario, the second communication node 104 may be referred to as a subsequent communication node with respect to the first communication node 102.

The electronic device 10 may compare a first trend of the first elevation angle 108 with a second trend of the second elevation angle 110 to determine whether to switch between communicating via the first communication node 102 and communicating via the second communication node 104. As an example, in response to determining that the first elevation angle 108 is decreasing and is below a first threshold angle, and determining that the second elevation angle 110 is increasing and is above a second threshold angle, the electronic device 10 may acquire received signal strengths or other suitable operating characteristics from each of the communication nodes 102, 104. In response to determining that a first received signal strength associated with the first communication node 102 is greater than a second received signal strength associated with the second communication node 104, the electronic device 10 may continue to communicate via the first communication node 102. However, in response to determining that the second received signal strength is greater than the first received signal strength, the electronic device 10 may switch from communicating via the first communication node 102 to communicating via the second communication node 104. That is, a subsequent signal transmitted by the electronic device 10 (e.g., intended for the entity 106) may be directed to the second communication node 104 instead of to the first communication node 102. The electronic device 10 may continue to receive the first received signal strength and the second received signal strength in response to determining the first elevation angle 108 is decreasing and is below the first threshold angle and the second elevation angle 110 is increasing and is above the second threshold angle to readily switch between communication nodes 102, 104 based on the comparison between received signal strengths.

Such operation of the electronic device 10 may enable the electronic device 10 to communication signals more desirably and/or successfully. For example, the electronic device 10 may prepare to communicate with a suitable communication node 102, 104 and avoid a period of time in which the relative positioning between the electronic device 10 and a current communication node 102, 104 (e.g., a serving communication node) may result in unsuccessful signal transmission (e.g., during a period of time in which the elevation angle 108, 110 between the electronic device 10 and the current communication node 102, 104 is below a threshold angle). For instance, the techniques discussed herein may enable the electronic device 10 to preemptively switch communication nodes 102, 104, such as before the electronic device 10 is unable to communicate a signal (e.g., caused by low elevation angle associated with a current communication node 102, 104). Thus, the electronic device 10 may continue to communicate signals and avoid a period of time during which communication of signals may be interrupted.

The electronic device 10 may additionally or alternatively switch between communication nodes 102, 104 based on other parameters, such as a beam orientation of a current communication node 102, 104. The beam orientation may be indicative of an orientation of a beam emitted by the communication node 102, 104 with respect to the electronic device 10 and may also indicate a likelihood of success of the communication node 102, 104 to receive a signal transmitted by the electronic device 10. For example, positioning of the electronic device 10 within the beam of the communication node 102, 104 may increase potential receipt of a signal transmitted by the electronic device 10, and an increased received signal strength or other operating characteristic may indicate the positioning of the electronic device 10 within a beam. The electronic device 10 may therefore determine the positioning of the electronic device 10 relative to the beam of a current communication node 102, 104 based on the received signal strength or other operating characteristic associated with the current communication node 102, 104, such as the electronic device 10 being positioned outside of the beam (e.g., the beam of the current communication node 102, 104 does not overlap with the electronic device 10 is therefore approaching null) based on a sudden decrease of the received signal strength (e.g., a sudden decrease during the rising edge and/or before the falling edge of the corresponding elevation angle 108, 110). Additionally or alternatively, the electronic device 10 may determine a positioning of the beam (e.g., based on pre-stored data, based on sensor data) and of the electronic device 10 to determine whether the electronic device 10 is positioned outside of the beam. In response to determining that the electronic device 10 is positioned outside of the beam of the current communication node 102, 104, and the elevation angle 108, 110 of the other of the communication nodes 102, 104 (e.g., a scheduled communication node) is increasing and is above a threshold angle, the electronic device 10 may acquire the received signal strength or other operating characteristic associated with each of the communication nodes 102, 104. Thus, even though the elevation angle 108, 110 between the current communication node 102, 104 and the electronic device 10 may be increasing and/or above a threshold angle, the electronic device 10 may switch communication nodes 102, 104 based on beam orientation to improve communication of signals.

In further embodiments, instead of the electronic device 10 itself operating to control switching between communication nodes 102, 104, such as based on comparison of the elevation angles 108, 110 and/or of the received signal strengths via the processor 12, the communication nodes 102, 104 may effectuate switching operations (e.g., handover operations, changeover operations). For example, the electronic device 10 may determine the trends of the elevation angles 108, 110 and/or obtain the received signal strengths and transmit the trends of the elevation angles 108, 110 and/or the received signal strengths to the first communication node 102 and/or the second communication node 104 (e.g., a current communication node utilized by the electronic device 10). The communication node(s) 102, 104 may then determine whether the electronic device 10 is to switch communication nodes 102, 104 based on the information received from the electronic device 10 and cause the electronic device 10 to operate accordingly. In this manner, the electronic device 10 may transmit the information to the communication node(s) 102, 104 (e.g., without performing further analysis, such as comparisons, of the received information), and the communication node(s) 102, 104 may analyze the information (e.g., compare the elevation angles 108, 110 and/or the received signal strengths to one another) and cause the electronic device 10 to switch communication nodes 102, 104 based on the information.

In certain embodiments, the electronic device 10 may also utilize the relative positioning and/or movement between the communication nodes 102, 104 to establish an initial communication link for communicating signals. That is, for example, prior there being an existing communication link established with one of the communication nodes 102, 104, the communication nodes 102, 104 may be unavailable to the electronic device 10 (e.g., elements, such as foliage, may have previously obstructed the line of sights 114, 116 to block communicative coupling between the electronic device 10 and the communication nodes 102, 104). Thus, the electronic device 10 may not utilize the communication nodes 102, 104 for communicating signals during this time. However, in response to a determination that the communication nodes 102, 104 are available for utilization (e.g., the line of sights 114, 116 are no longer being obstructed), the electronic device 10 may attempt to establish a communication link with one of the communication nodes 102, 104.

A duration of time spent by the electronic device 10 to attempt to establish a communication link with each communication node 102, 104 may be based on different parameters. As an example, the duration of time may be based on the elevation angle 108, 110, the trend of the elevation angle 108, 110 (e.g., rising edge, falling edge), and/or the position of the electronic device 10 within a beam of an associated communication node 102, 104. The duration of time may also be based on clearance of the line of sights 114, 116 (e.g., amount of elements, such as foliage, obstructing the line of sights 114, 116), orientation of the electronic device 10 (e.g., with respect to the communication nodes 102, 104, with respect to the elevation angles 108, 110, with respect to an azimuth), and/or any other suitable parameter. The electronic device 10 may calculate the duration of time associated with each available communication node 102, 104 based on the respective parameters corresponding to the communication nodes 102, 104, such as via an algorithm and/or a lookup table that associates a value of the duration of time with different parameter values.

Upon determining the durations of time associated with each communication node 102, 104, the electronic device 10 may sequentially attempt to establish a communication link with the communication nodes 102, 104 in order of descending associated durations of time until a communication link has been successfully established. That is, for example, in response to determining that a first duration of time associated with the first communication node 102 is greater than a second duration of time associated with the second communication node 104, the electronic device 10 may initially attempt to establish a communication link with the first communication node 102 before attempting to establish a communication link with the second communication node 104. For instance, the electronic device 10 may transmit one or more initial signals to the first communication node 102 and determine whether a response signal is transmitted from the first communication node 102 to indicate a successful receipt of the one or more initial signals for establishment of the communication link In response to determining that the response signal has been received from the first communication node 102, the electronic device 10 may determine that the communication link with the first communication node 102 has been successfully established, and the electronic device 10 may communicate subsequent signals via the first communication node 102. As such, the electronic device 10 may determine that a communication link with the second communication node 104 may no longer be needed.

However, in response to determining that a response signal has not been received from the first communication node 102, thereby indicating that the communication link has not been successfully established with the first communication node 102, the electronic device 10 may continue to transmit the initial signals to attempt to establish the communication link with the first communication node 102. The electronic device 10 may continually or repeatedly transmit the initial signals (e.g., at a particular interval) for the first duration of time associated with the first communication node 102. After the first duration of time has elapsed and a communication link has not been established with the first communication node 102, the electronic device 10 may then attempt to establish a communication link (e.g., by transmitting initial signals) with the second communication node 104 until the communication link with the second communication node 104 has been successfully established or the second duration of time associated with the second communication node 104 has elapsed. In this manner, the electronic device 10 may attempt to establish communication links in a more suitable manner with various communication nodes 102, 104 based on different parameters. For example, operation to establish a communication link for a duration of time calculated based on parameter values may improve potential to establish a communication link, limit unnecessary time spent to establish a communication link (e.g., with a communication node 102, 104 that may not have high potential for establishment of a communication link), and/or reduce power consumption associated with establishing communication links.

Although the illustrated communication system 100 includes two communication nodes 102, 104 available for communicating signals transmitted by or to the electronic device 10, the communication system 100 may include any suitable number of available communication nodes, such as more than two communication nodes, in additional or alternative embodiments. The techniques discussed herein may be similarly implemented in such embodiments. By way of example, the electronic device 10 may determine respective trends of elevation angles, and the electronic device 10 may switch between communicating via any of the available communication nodes based on the trends. Additionally or alternatively, the electronic device 10 may determine respective durations of time associated with each of the communication nodes and sequentially attempt to establish a communication link based on the durations of time. In this manner, the electronic device 10 may operate using the techniques discussed herein regardless of the number of available communication nodes to improve communication of signals.

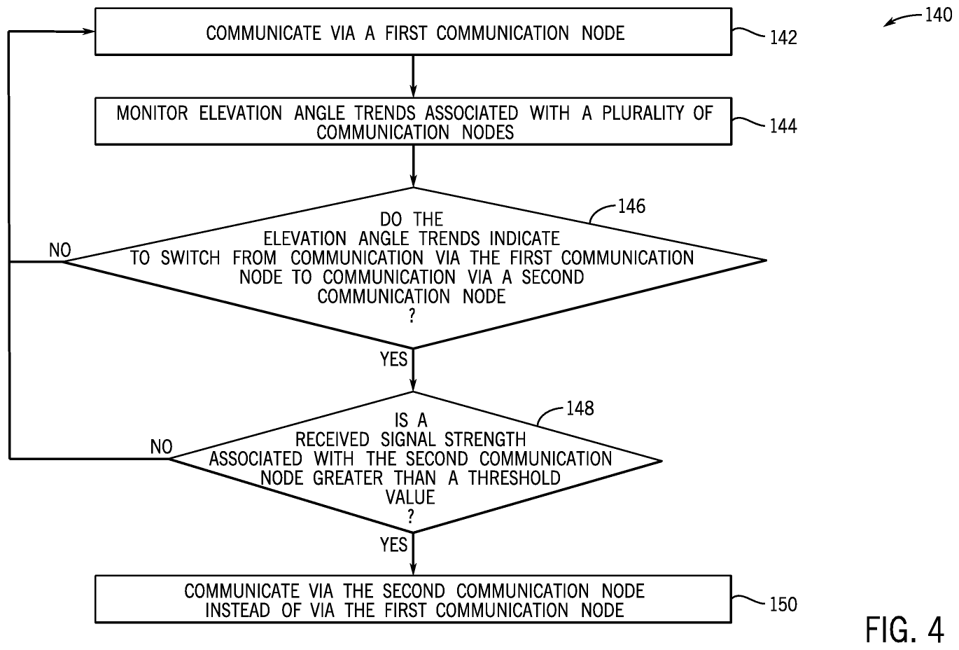

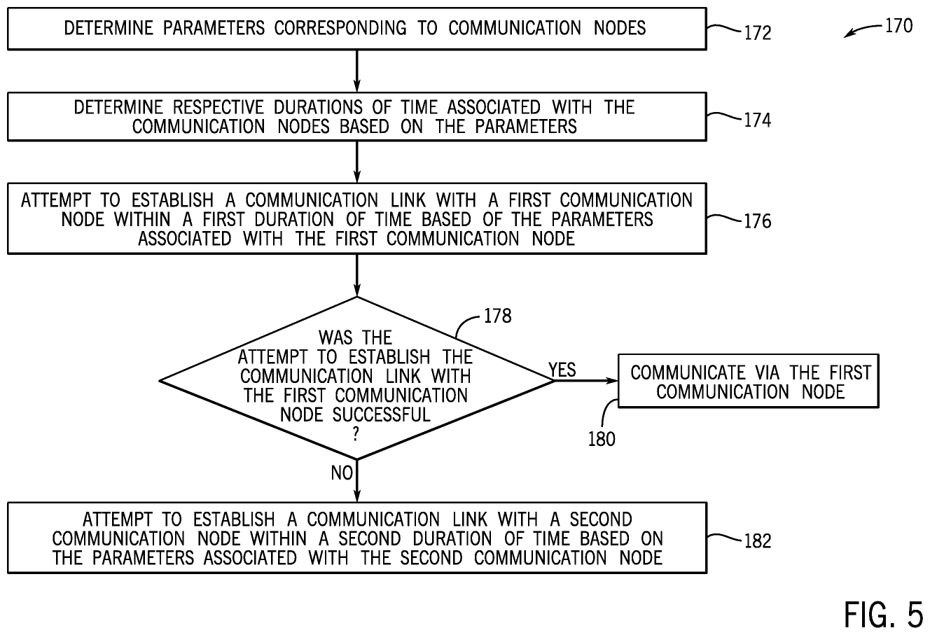

Each of FIGS. 4 and 5 described below illustrates a respective method for communicating signals via an electronic device 10. Any suitable device, such as the processor 12 and/or processors of the communication nodes 102, 104 may perform the methods. In some embodiments, each of the methods may be implemented by executing instructions stored in a tangible, non-transitory, computer-readable medium, such as the memory 14 or storage 16, or memory or storage of the communication nodes 102, 104, using the processor 12 and/or processors of the communication nodes 102, 104. For example, the methods may be performed at least in part by one or more software components, such as an operating system of the electronic device 10 and/or the communication nodes 102, 104, one or more software applications of the electronic device 10 and/or the communication nodes 102, 104, and the like. While each of the methods is described using operations in a specific sequence, additional operations may be performed, the described operations may be performed in different sequences than the sequence illustrated, and certain described steps may be skipped or not performed altogether. Further still, the operations of any of the respective methods may be performed in any suitable manner with respect to one another, such as in a sequential manner. Moreover, while the methods of FIGS. 4 and 5 are described with respect to communication between the electronic device 10 and the communication node 102 and/or the communication node 104, the techniques described herein may be implemented for communication between the electronic device 10 and any other recipient, such as the entity 106.

FIG. 4 is a flowchart of a method 140 for switching between communication nodes to communicate a signal. At block 142, the electronic device 10 may communicate via a first communication node (e.g., the first communication node 102), which may be a serving communication node. For example, the processor 12 may cause the transceiver 30 to transmit a signal directed to the first communication node, and the first communication node may forward the signal to a recipient. The electronic device 10 may have initially established a communication link via the first communication node based on a first received signal strength or other operating characteristic associated with the first communication node being above a threshold value. In certain embodiments, the processor 12 may continue to determine the first received signal strength to verify that the electronic device 10 is to communicate via the first communication node (e.g., based on the first received signal strength being above the threshold value).

While the electronic device 10 communicates via the first communication node, at block 144, the processor 12 may monitor elevation angle trends associated with multiple communication nodes, which may include the first communication node. In some embodiments, the processor 12 may monitor the elevation angle trends based on pre-stored data (e.g., TLE and/or ephemeris data), such as data previously received from another system. In additional or alternative embodiments, the processor 12 may monitor the elevation angle trends in real time, such as based on data received from the sensor 118.

At block 146, the processor 12 may determine whether the elevation angle trends indicate to switch from communicating via the first communication node to communicating via a second communication node (e.g., the second communication node 104), which may be a neighbor communication node and/or a subsequent communication node. For instance, the processor 12 may compare the elevation trends associated with different communication nodes to one another to determine, predict, or project whether the second communication node may be more suitable for communicating subsequent signals. As an example, the elevation angle trends may indicate to switch communication nodes based on a first elevation angle associated with the first communication node being below a first threshold angle and/or a first trend of the first elevation angle decreasing over time (e.g., providing a falling edge), and a second elevation angle associated with the second communication node being above a second threshold angle and/or a second trend of the second elevation angle is an increasing elevation angle over time (e.g., providing a rising edge). In some embodiments, the first threshold angle (e.g., an angle between 20 and 30 degrees, an angle between 30 and 40 degrees, an angle greater than 40 degrees) may be greater than the second threshold angle (e.g., an angle between 10 and 20 degrees, an angle less than 10 degrees).

In response to determining that the elevation angle trends do not indicate to switch from communicating via the first communication node to communicating via the second communication node, the electronic device 10 may continue to communicate via the first communication node, such as via the technique described at block 142. For example, the first elevation angle may be above the first threshold angle, the first trend of the first elevation angle may not be a decreasing elevation angle over time (e.g., the first elevation angle may be an increasing or constant elevation angle over time), the second elevation angle may be below the second threshold angle, and/or the second trend of the second elevation angle may not be an increasing elevation angle over time (e.g., the second elevation angle may be a decreasing or constant elevation angle over time). However, in response to determining that the elevation angle trends indicate to switch from communicating via the first communication node to communicating via the second communication node, the processor 12 may determine a second received signal strength or other operating characteristic associated with the second communication node.

At block 148, the processor 12 determines whether the second received signal strength associated with the second communication node is greater than a threshold value. In some embodiments, the processor 12 may establish the first received signal strength associated with the first communication node as the threshold value. Thus, the processor 12 may determine whether the second received signal strength is greater than the first received signal strength. In additional or alternative embodiments, the processor 12 may establish the threshold value as a predetermined or preset value that is separate from the first received signal strength.

In response to determining that the second received signal strength is not greater than the threshold value, the electronic device 10 may continue to communicate via the first communication node. For instance, the processor 12 may determine that the second received signal strength is less than the threshold value, thereby indicating that signals may not be successfully communicated to the second communication node. However, at block 150, in response to determining that the second received signal strength is greater than the threshold value, the electronic device 10 may communicate via the second communication node instead of via the first communication node. That is, the processor 12 may cause the transceiver 30 to transmit a subsequent signal directed to the second communication node instead of directed to the first communication node, and the second communication node may forward the subsequent signal to a recipient.

It should be noted that other data or parameters may be used to determine whether the electronic device 10 is to switch from communication via the first communication node to communication via the second communication node. As an example, the processor 12 may determine the position of the electronic device 10 with respect to a beam of the first communication node. The processor 12 may determine that the electronic device 10 is to switch from communication via the first communication node to communication via the second communication node in response to determining that the beam of the first communication node is approaching null (e.g., as indicated by a sudden decrease of the first received signal strength), whereas the second elevation angle associated with the second communication node is above the second threshold angle and/or the second trend of the second elevation angle is an increasing elevation angle over time. The processor 12 may then determine the second received signal strength for comparison with the first received signal strength to determine whether to switch communication via the communication nodes. Other data, such as obstruction of the line of sight from the electronic device 10 to the first communication node, orientation and/or location of the electronic device 10 relative to the first communication node, or any other suitable data may additionally or alternatively be used to determine whether the electronic device 10 is to switch communication via the communication nodes (e.g., upon comparing the received signal strengths).

It should be noted that the electronic device 10 may continually perform the method 140 to determine whether communication nodes should be switched. For example, after switching to communicate via the second communication node, the processor 12 may monitor elevation angle trends to determine whether communications should be switched from the second communication node (e.g., to communicate via the first communication node, to communicate via a third communication node). In this manner, the electronic device 10 may continue to communicate via a suitable communication node, such as to avoid an occurrence in which the electronic device 10 is unable to communicate a signal to a communication node (e.g., caused by a sudden, unanticipated, or unscheduled decrease in elevation angle of a currently used communication node).

FIG. 5 is a flowchart of a method 170 for establishing a communication link with a communication node. For example, the electronic device 10 may perform the method 170 while no communication links between the electronic device 10 and communication nodes are currently established (e.g., the electronic device 10 has been out of service), such as in response to determining that a previously utilized communication node is no longer available. At block 172, the processor 12 may receive various parameters corresponding to different communication nodes that may be available for establishment of communication links. For example, the processor 12 may initially determine elevation angles of a plurality of communication nodes that may or may not be available. The processor 12 may determine a set (e.g., a subset) of communication nodes of the plurality of communication nodes are available in response to determining the elevation angle of each communication node in the set of communication nodes are above a threshold angle (e.g., an angle between 0 and 10 degrees, an angle between 10 and 20 degrees, an angle between 20 and 30 degrees). In response, the processor 12 may determine the parameters corresponding to such communication nodes. In additional or alternative embodiments, the processor 12 may identify available communication nodes using a different parameter and/or may determine parameters corresponding to communication nodes without initially determining whether the communication nodes are available.

In some embodiments, the parameters may include the elevation angle, a trend of the elevation angle, a position of the electronic device 10 with respect to a beam, clearance of a line of sight, and/or orientation of the electronic device 10. For instance, the processor 12 may determine the elevation angle, the trend of the elevation angle, and/or the position of the electronic device 10 with respect to the beam based on pre-stored data (e.g., TLE data), sensor data, or any other data indicative of the relative positioning between the electronic device 10 and the communication nodes. The processor 12 may determine the clearance of the line of sight based on an image captured by the electronic device 10 (e.g., pointed toward the sky, pointed toward the communication nodes), such as by determining an amount, a positioning, and/or a size of objects (e.g., foliage) in the captured image. The processor 12 may determine the orientation of the electronic device 10 (e.g., with respect to the elevation angle, with respect to an azimuth, with respect to the communication nodes) based on sensor data (e.g., indicative of movement of the electronic device 10).

At block 174, the processor 12 may determine respective durations of time associated with the communication nodes based on the respective parameters. That is, for example, the processor 12 may determine a first duration of time associated with a first communication node based on the parameters corresponding to the first communication node, and the processor 12 may determine a second duration of time associated with a second communication nodes based on the parameters corresponding to the second communication node. In some embodiments, the processor 12 determine the respective durations of time by using a weighted calculation that associates a value of a duration of time with different parameter values. By way of example, the duration of time may be calculated based on Equation 1:

Duration of time=A*v+B*w+C*x+D*y+E*z Equation 1

in which v is a value indicative of a first parameter (e.g., a clearance of a line of sight), w is a value indicative of a second parameter (e.g., an elevation angle), x is a value indicative of a third parameter (e.g., a trend of an elevation angle), y is a value indicative of a fourth parameter (e.g., position of the electronic device 10 with respect to a beam), z is a value indicative of a fifth parameter (e.g., an orientation of the electronic device 10), and A, B, C, D, and E are respective weighted values for each of the parameters (e.g., the sum of A, B, C, D, and E may equal to 100%). In certain embodiments, the parameters may include qualitative characteristics, and the values of the parameters may include quantitative measurements assigned to the qualitative characteristics. By way of example, Table 1 below provides example values to determine durations of time.

TABLE 1

| Parameter | Parameter Value | Weight (%) |
|---|---|---|
| Clearance | No obstruction: 4; | 40 |
| | Light obstruction: 3; | |
| | Medium obstruction: 2; | |
| | Heavy obstruction: 1 | |
| Elevation Angle (degrees) | Elevation angle/10 | 30 |
| Trend of elevation angle | Increasing (e.g., rising | 15 |
| | edge): 2; Decreasing | |
| | (e.g., falling edge): 1 | |
| Device position with | Good: 2; Poor: 1 | 15 |
| respect to beam | | |
| Device orientation | Pointing to | 10 |
| | communication node: | |
| | 2; Not pointing to | |
| | communication node: 1 | |

additional or alternative embodiments, the processor 12 may determine the durations of time using another technique, such as a lookup table. Indeed, the processor 12 may utilize any suitable data or information that associates values of duration of time with corresponding, respective parameter values to determine the respective durations of time associated with the communication nodes.

Upon calculating the durations of time, the processor 12 may compare the durations of time with one another to determine a communication node for attempting to establish a communication link. For example, the processor 12 may determine an order in which communication links are attempted to be established with the different communication nodes based on the durations of time, such as in descending durations of time associated with the communication links. For instance, in response to determining that a first duration of time associated with a first communication node is greater than a second duration of time associated with a second communication node, the processor 12 may attempt to establish a communication link with the first communication node before attempting to establish a communication link with the second communication node.

At block 176, the processor 12 may select a communication node for attempting to establish a communication link based on the comparison of durations of time. In the illustrated embodiment, the processor 12 selects the first communication node having an associated first duration of time, which may be of the greatest value amongst the determined respective durations of time. During the attempt to establish the communication link with the first communication node, the processor 12 may cause the transceiver 30 to transmit signals to the first communication node and determine whether the first communication node receives the transmitted signals. As an example, the processor 12 may determine whether a response signal transmitted by the first communication node is received at the electronic device 10 to indicate successful receipt of the transmitted signals by the electronic device 10. The processor 12 may continue to transmit the signals until the response signal is received and/or the first duration of time associated with the first communication node has elapsed.

At block 178, the processor 12 may determine whether a communication link has been successfully established with the first communication node within the first duration of time. For example, the processor 12 may determine whether a response signal is received within the first duration of time to indicate successful establishment of the communication link with the first communication node before the first duration of time has elapsed. In response to determining that the communication link is successfully established with the first communication node within the first duration of time, the electronic device 10 may communicate via the first communication node, as shown at block 180. For instance, the processor 12 may cause the transceiver 30 to transmit a subsequent signal directed to the first communication node for forwarding to a recipient.

However, at block 182, in response to determining that the communication link is not successfully established with the first communication node within the first duration of time, the processor 12 may attempt to establish a communication link with a second communication node instead of with the first communication node. For example, the processor 12 may determine that the first duration of time has elapsed before successful establishment of the communication link with the first communication node. As a result, the processor 12 may suspend operation to establish the communication link with the first communication node. The processor 12 may then determine that a second duration of time associated with the second communication node is of the next highest value amongst the determined respective durations of time with respect to the first duration of time. In response, the processor 12 may attempt to establish the communication link with the second communication node within the second duration of time, such as by transmitting signals to the second communication node and determining whether a response signal is received from the second communication node.

The electronic device 10 may continue to perform a similar technique for an additional communication node. That is, for example, in response to determining that the attempt to establish the communication link with the second communication node was unsuccessful within the second duration of time, the electronic device 10 may attempt to establish a communication link with a third communication node within a third duration of time (e.g., based on the third duration of time being the next highest value with respect to the second duration of time). Indeed, the electronic device 10 may continue to attempt to establish a communication link with different communication nodes until a communication link has been successfully established with a communication node.

In some embodiments, after an attempt to establish a communication link has been made for each available communication node, the electronic device 10 may repeat performance of the method 170. For example, the electronic device 10 may determine updated available communication nodes (e.g., based on elevation angles that may have changed during performance of the method 170), updated parameters corresponding to the updated available communication nodes, and updated respective durations of times associated with the updated available communication nodes based on the updated parameters. The electronic device 10 may then attempt to establish a communication link accordingly (e.g., with a communication node having the highest duration of time). In some circumstances, the updated available communication nodes may include a communication node with which the electronic device 10 attempted to establish a communication link during a prior performance of the method 170. As such, the electronic device 10 may attempt to establish a communication link with a communication node multiple times as a result of repeated performance of the method 170. Additionally or alternatively, the updated available communication nodes may include a new communication node that was not available during a prior performance of the method 170. Thus, the electronic device 10 may attempt to establish a communication link with a different communication node during different performances of the method 170.

Embodiments of the present disclosure are directed to operating an electronic device (e.g., a mobile communicating device) to communicate signals, such as to transmit a signal directed to a communication node for subsequent transmission to a target recipient. The electronic device may initially communicate signals via a first communication node and monitor elevation angles associated with different communication nodes while communicating signals via the first communication node. The electronic device may then determine whether the elevation angles indicate to switch from communicating via the first communication node to communicating via a second communication node. For example, a trend of a first elevation angle of the first communication node may be decreasing over time and a trend of a second elevation angle of the second communication node may be increasing over time. As a result, the electronic device may obtain a respective received signal strength or other operating characteristic associated with the first communication node and the second communication node. The electronic device may then switch from communicating via the first communication node to communicating via the second communication node in response to determining the received signal strength associated with the second communication node is greater than the received signal strength associated with the first communication node. Such operation to switch communication nodes may enable the electronic device to continue to communicate signals to a target recipient. For example, the electronic device may avoid a period of time in which a current communication node is unavailable because of a reduced elevation angle. Thus, operation of the electronic device to communicate signals to the target recipient via a suitable communication node may be improved.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device, comprising:
a transmitter; and
processing circuitry communicatively coupled to the transmitter and configured to
transmit a signal directed to a first communication node using the transmitter, and
transmit an additional signal directed to a second communication node using the transmitter based on a trend of a position of the second communication node.

2. The electronic device of claim 1, wherein the position comprises an elevation angle of the second communication node relative to the electronic device.

3. The electronic device of claim 2, wherein the processing circuitry is configured to transmit the additional signal directed to the second communication node using the transmitter based on the trend of the elevation angle of the second communication node indicating an increasing elevation angle over time.

4. The electronic device of claim 3, wherein the processing circuitry is configured to transmit the additional signal directed to the second communication node using the transmitter based on the trend of the elevation angle of the second communication node indicating the increasing elevation angle over time and an additional trend of an additional elevation angle of the first communication node indicating a decreasing elevation angle over time.

5. The electronic device of claim 3, wherein the processing circuitry is configured to transmit the additional signal directed to the second communication node using the transmitter based on the trend of the elevation angle of the second communication node indicating the increasing elevation angle over time and that the elevation angle of the second communication node being above a threshold value.

6. The electronic device of claim 3, wherein the processing circuitry is configured to transmit the additional signal directed to the second communication node using the transmitter based on the trend of the elevation angle of the second communication node indicating the increasing elevation angle over time and that an additional elevation angle of the first communication node being below a threshold value.

7. The electronic device of claim 3, wherein the processing circuitry is configured to transmit the additional signal directed to the second communication node using the transmitter based on the trend of the elevation angle of the second communication node indicating the increasing elevation angle over time and that a beam of the first communication node approaching null.

8. The electronic device of claim 1, comprising memory, wherein the processing circuitry is configured to determine the trend of the position of the second communication node based on data stored in the memory.

9. A non-transitory computer-readable medium, comprising instructions that, when executed by processing circuitry, are configured to cause the processing circuitry to:
transmit a signal directed to a first communication node using a transmitter of an electronic device; and
transmit an additional signal directed to a second communication node using the transmitter based on a first trend of a first elevation angle with respect to the electronic device and a second trend of a second elevation angle with respect to the electronic device.

10. The non-transitory computer-readable medium of claim 9, wherein the instructions, when executed by the processing circuitry, are configured to cause the processing circuitry to:
determine a first received signal strength associated with the first communication node and a second received signal strength associated with the second communication node based on the first trend of the first elevation angle and the second trend of the second elevation angle; and
transmit the additional signal directed to the second communication node using the transmitter based on the second received signal strength being greater than the first received signal strength.

11. The non-transitory computer-readable medium of claim 10, wherein the instructions, when executed by the processing circuitry, are configured to cause the processing circuitry to determine the first received signal strength and the second received signal strength based on the second trend of the second elevation angle comprising an increasing elevation angle.

12. The non-transitory computer-readable medium of claim 10, wherein the instructions, when executed by the processing circuitry, are configured to cause the processing circuitry to determine the first received signal strength and the second received signal strength based on the first trend of the second elevation angle comprising a decreasing elevation angle.

13. The non-transitory computer-readable medium of claim 10, wherein the instructions, when executed by the processing circuitry, are configured to cause the processing circuitry to transmit the additional signal directed to the first communication node using the transmitter based on the first received signal strength being greater than the second received signal strength.

14. The non-transitory computer-readable medium of claim 9, wherein the instructions, when executed by the processing circuitry, are configured to cause the processing circuitry to determine the first trend of the first elevation angle, the second trend of the second elevation angle, or both based on pre-stored data.

15. The non-transitory computer-readable medium of claim 9, wherein the instructions, when executed by the processing circuitry, are configured to cause the processing circuitry to:
determine that communication via the first communication node is unavailable;
determine a plurality of parameters corresponding to the second communication node based on the communication via the first communication node being unavailable;
determine a duration of time based on the plurality of parameters; and
attempt to establish a communication link with the second communication node within the duration of time.

16. A method, comprising:
determining, via processing circuitry of an electronic device, a plurality of parameters corresponding to a communication node, the plurality of parameters comprising a trend of an elevation angle between the communication node and the electronic device;
determining, via the processing circuitry, a duration of time based on the plurality of parameters; and
attempting, via the processing circuitry, to establish a communication link between the electronic device and the communication node within the duration of time.

17. The method of claim 16, comprising:
determining, via the processing circuitry, that the communication link is established between the electronic device and the communication node within the duration of time, and
transmitting, via the processing circuitry, a signal directed to the communication node using a transceiver of the electronic device based on the communication link being established between the electronic device and the communication node within the duration of time.

18. The method of claim 17, comprising:
determining, via the processing circuitry, unsuccessful establishment of the communication link between the electronic device and the communication node within the duration of time;
determining, via the processing circuitry, an additional plurality of parameters corresponding to an additional communication node;
determining, via the processing circuitry, an additional duration of time based on the additional plurality of parameters; and
attempting, via the processing circuitry, to establish a communication link between the electronic device and the additional communication node within the additional duration of time.

19. The method of claim 18, comprising attempting to establish the communication link between the electronic device and the communication node prior to attempting to establish the communication link between the electronic device and the additional communication node based on the duration of time associated with the attempt to establish the communication link between the electronic device and the communication node being greater than the additional duration of time associated with the attempt to establish the communication link between the electronic device and the additional communication node.

20. The method of claim 16, comprising determining, via the processing circuitry, the duration of time based on a weighted calculation associating a value of the duration of time with a value of the trend of the elevation angle.
